(19) United States
(12) Patent Application Publication
(10) Pub. No.: US 2005/0206611 A1
(43) Pub. Date: Sep. 22, 2005

(54) Audio and video playing method

(75) Inventors: Wan-Yin Ching, Penang (MY); Shih-Hsiung Weng, Taipei (TW)

Correspondence Address: Mr. Peter F. Corless, EDWARDS & ANGELL, LLP, 101 Federal Street, Boston, MA, 02110, US

(73) Assignee: Inventec Multimedia & Telecom Corporation, Taipei (TW)

(21) Appl. No.: 10/802,496

(22) Filed: Mar. 16, 2004

(51) Int. Cl. G10H 7/00; G09G 5/00

(52) U.S. Cl. 345/156

(57) ABSTRACT

An audio and video playing method is provided, applied to a computer device having a memory unit and a data input unit. When a user enters a playing mode of simultaneously playing songs and displaying images to the computer device via the data input unit, the computer device executes an audio and video playing program stored in the memory unit to play songs and displaying corresponding images intended by the user, such that the user can conveniently and efficiently playing songs of MP3 files and displaying animated images associated therewith simultaneously without having to perform complicated operating processes as in the prior art.

### FIELD OF THE INVENTION

The present invention relates to audio and video playing methods, and more particularly, to a method for simultaneously playing a song of a MP3 file format and executing an image file associated therewith.

### BACKGROUND OF THE INVENTION

With advancement in computer technology, for example development of multimedia, a computer is provided with multiple functions such as entertainment, communication, calculation and so on, making learning more interesting to perform in the life through the use of the computer. In concern of file sizes for storage, digital sound files are normally compressed as a MP3 (MPEG audio layer-3) format to greatly reduce sizes of the sound files.

Generally in a process for playing MP3 files, the computer is merely capable of displaying animated images in the form of different waves in accordance with sound frequencies. Further, MP3 sound files and animated image files are of different file formats, which file formats are not compatible with each other and thereby require different drivers to execute the sound and image files respectively. For example, for downloading a driver for MP3 files, a user needs to specifically designate the driver to MP3 files, and then activates the driver and manually selects the MP3 file to be executed, making operation of file execution relatively inconvenient to implement.

Therefore, the problem to be solved herein is to provide a simplified operating process for simultaneously playing sounds or songs of a MP3 file format and displaying animated images associated therewith.

### SUMMARY OF THE INVENTION

A primary objective of the present invention is to provide an audio and video playing method, for allowing a user to conveniently and efficiently playing sounds or songs of MP3 files and displaying animated images associated therewith simultaneously.

In accordance with the foregoing and other objectives, the present invention proposes an audio and video playing method, which is applied to a computer device having a memory unit and a data input unit. The audio and video playing method comprises the following steps. First, the memory unit is divided at least into a song storage region, an image file storage region, an audio and video playing program region, and a play setting data region. When the computer device receives data transferred from the data input unit, it determines the type of data; for an image file, it is stored in the image file storage region of the memory unit; for a sound file, it is stored in the song storage region of the memory unit. Then, a user sets a playing mode via the data input unit of the computer device, wherein the computer device displays data of playing modes on a display unit thereof, and the playing modes at least include a mode for playing songs only and a mode for simultaneously playing songs and displaying images. When the computer device receives a playing mode for simultaneously playing songs and displaying images from the user, it finds out data of songs and image files from the song storage region and image file storage region of the memory unit for allowing the user to select an intended song and a corresponding image file. Then, the computer device establishes a form of correlation between songs and image files according to the setting and selection made by the user, and stores the correlation form in the play setting data region of the memory unit. When the computer device receives a song playing request from the user via the data input unit, it executes an audio and video playing program stored in the audio and video playing program region of the memory unit in accordance with data stored in the play setting data region.

### BRIEF DESCRIPTION OF THE DRAWINGS

The present invention can be more fully understood by reading the following detailed description of the preferred embodiments, with reference made to the accompanying drawings, wherein:

FIG. 1 is a schematic block diagram showing the architecture of a computer device applied with an audio and video playing method according to the invention;

FIG. 2 is a flow chart showing procedural steps for storing and deleting image files prior to performing the audio and video playing method according to the invention;

FIG. 3 is a flow chart showing procedural steps for performing the audio and video playing method according to the invention; and

FIG. 4A is a schematic diagram showing correlation between MP3 song files and image files established through the use of the audio and video playing method according to the invention.

### DETAILED DESCRIPTION OF THE PREFERRED EMBODIMENTS

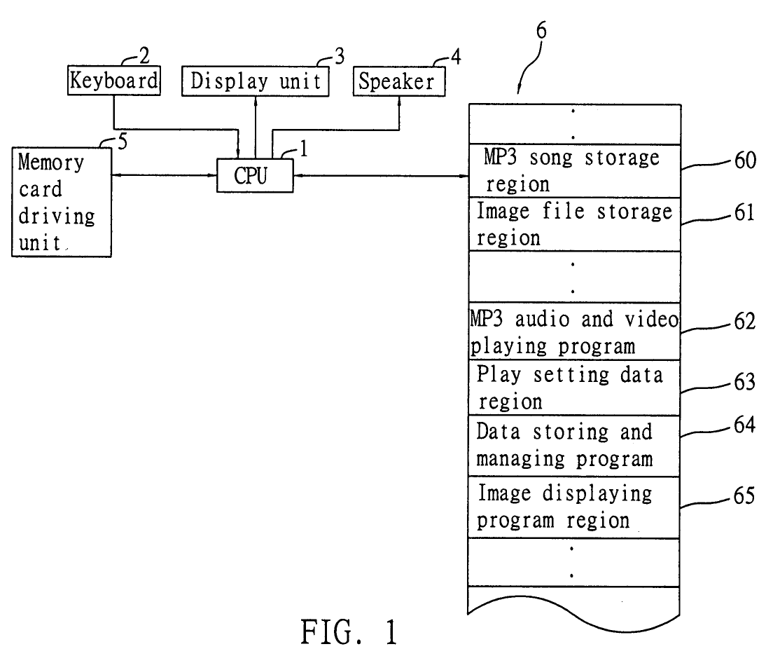

FIG. 1 illustrates the architecture of a computer device applied with an audio and video playing method according to the present invention. As shown in the drawing, the audio and video playing method is applied to a computer device such as notebook personal computer, desktop computer, digital camera, digital video camera, cellular phone, personal digital assistant (PDA) and so on. This computer device is at least provided with a central processing unit (CPU) 1, a data input unit such as keyboard 2, a display unit 3, a speaker 4, a memory card driving unit 5, and a memory unit 6. These computer-associated components are well known in the art and thereby not further detailed with functions and internal structures thereof irrelevant to the audio and video playing method according to the invention hereinafter.

The memory card driving unit 5 is connected with the CPU 1 and used to read a memory card inserted therein by a user, wherein the memory card may be for example, CF (compact flash) card, PCMCIA (personal computer memory card international association) and SM (smart media) card, to store data including compressed files of images and pictures in “jpeg”, “gif” and “mpeg” formats, and compressed files of sounds and songs in a MP3 format.

The memory unit 6, such as hard disk (HDD) common in a computer, is connected with the CPU 1. Storage of the memory unit 6 can be divided into a MP3 song storage region 60, an image file storage region 61, a MP3 audio and video playing program 62, a play setting data region 63, a data storing and managing program 64, and an image displaying program region 65. When the user intends to perform a data storing process, for example to transfer data stored in the memory unit 6 to a memory card inserted in the memory card driving unit 5, or to transfer data stored in the memory card of the memory card driving unit 5 to the memory unit 6, he or she normally selects a data storage function via the keyboard 2, which prompts the computer device to execute the data storing and managing program 64 of the memory unit 6, making the CPU 1 process data to be MP3 files or image files according to the type of data and store MP3 files in the MP3 song storage region 60 and images files in the image file storage region 61 respectively.

Moreover, during the data storing process in the computer device, playing settings or modes (not shown) are displayed on the display unit 3 and at least include a mold for playing MP3 songs only and a mold for simultaneously playing MP3 songs and displaying images, for allowing the user to enter an intended playing mode via the keyboard 2 and storing the entered data of playing mode or setting in the play setting data region 63. As such, when the user submits a playing request to the computer device, the MP3 audio and video playing program 62 of the memory unit 6 is executed with the stored playing mode or setting from the play setting data region 63.

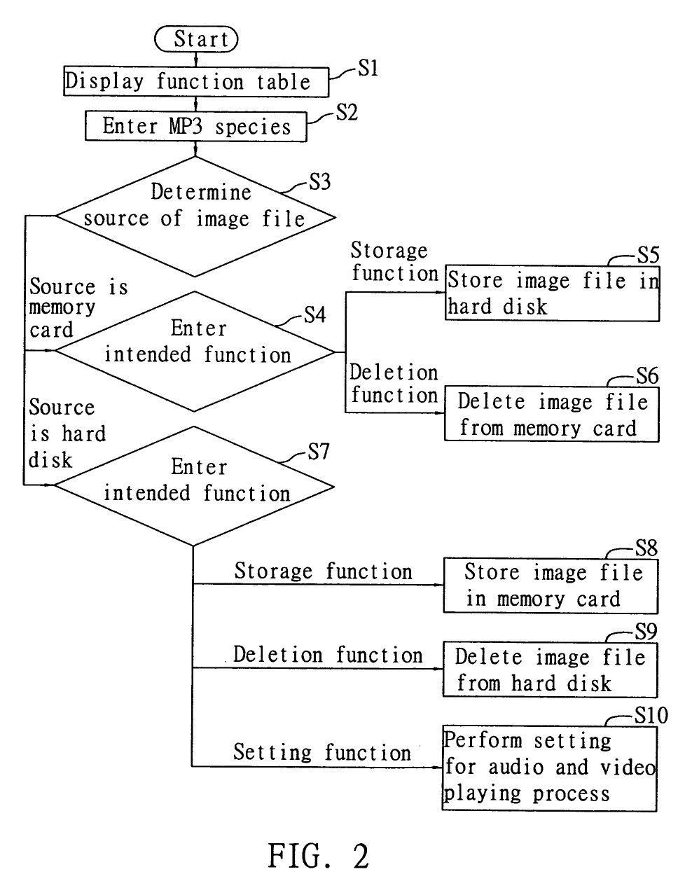

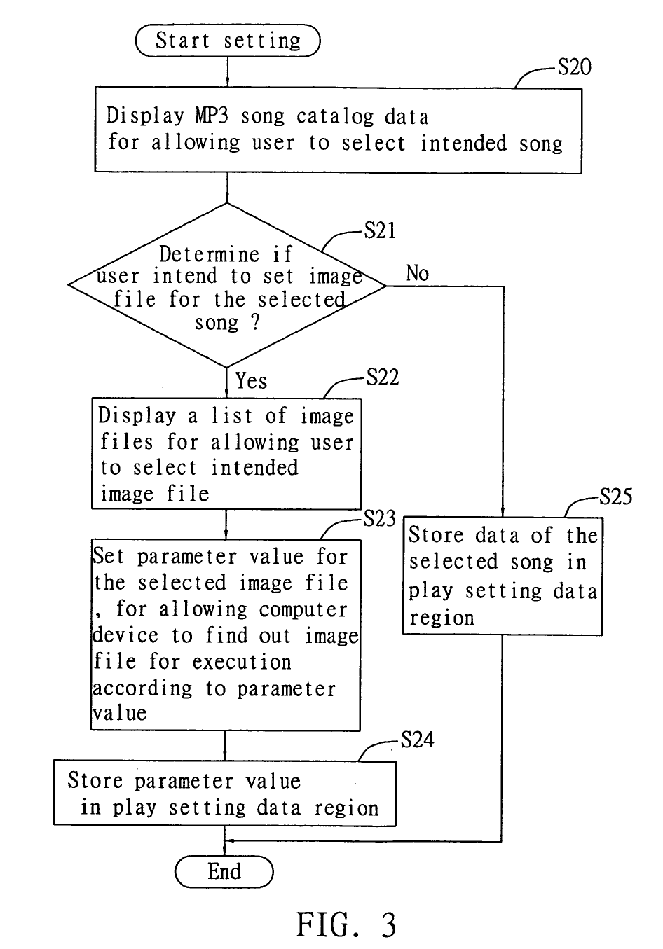

The procedural steps for performing the audio and video playing method according to the invention are described as follows with reference to FIGS. 2 and 3.

FIG. 2 illustrates procedural steps for processing image files prior to performing the audio and video playing method, wherein the processing of image files includes setting sources of image files and storing or deleting the image files. As shown in the drawing, first in step S1, the display unit 3 of the computer device displays a function table (not shown) showing a plurality of species of file formats to be executed, for allowing a user to enter an intended species via the keyboard 2. Then, step S2 is performed.

In step S2, if the computer device receives a signal of MP3 species entered from the keyboard 2, it indicates that the user intends to perform a process for storing image files. Then, step S3 is performed.

In step S3, the computer device prompts the display unit 3 to display an input field (not shown) for allowing the user to input a source of image files thereto via the keyboard 2. If the input file source is a memory card, then step S4 is performed; if the input source is a hard disk, then step S7 is performed.

In step S4, upon receiving data indicating the file source being a memory card from the keyboard 2, the computer device urges the display unit 3 to display a function menu (not shown) for allowing the user to enter an intended function via the keyboard 2. If a storage function is entered, step S5 is performed; if a deletion function is entered, then step S6 is performed.

In step S5, the computer device stores image files of the memory card inserted in the memory card driving unit 5 into the image file storage region 61 of the memory unit 6 (such as hard disk), and it completes the process for storing image files.

In step S6, the computer device deletes image files from the memory card inserted in the memory card driving unit 5, and it completes the process for deleting image files.

In step S7, upon receiving data indicating the file source being a hard disk (i.e. memory unit 6) from the keyboard 2, the computer device urges the display unit 3 to display a function menu (not shown) for allowing the user to enter an intended function via the keyboard 2. If a storage function is entered, step S8 is performed; if a deletion function is entered, then step S9 is performed; and if a setting function is entered, then step S10 is performed.

In step S8, the computer device stores image files of the image file storage region 61 of the memory unit 6 into the memory card inserted in the memory card driving unit 5, and it completes the process for storing image files.

In step S9, the computer device deletes image files from the image file storage region 61 of the memory unit 6, and it completes the process for deleting image files.

In step S10, the computer device prompts the display unit 3 to display a setting picture (not shown) for allowing the user to input setting data via the keyboard 2, whereby the computer device performs an audio and video playing process in accordance with the user's settings to be detailed with reference to FIG. 3 as follows.

FIG. 3 illustrates procedural steps for performing the audio and video playing method according to the invention. As shown in FIG. 3, first in step S20, the computer device obtains song catalog data from the MP3 song storage region 60 of the memory unit 6 and displays the song catalog data on the display unit 3, allowing a user to enter an intended MP3 song via the keyboard 2. Then, step S21 is performed.

In step S21, upon receiving the entered MP3 song from the keyboard 2, it determines if the user intends to set an image file for the MP3 song file; if yes, then step S22 is performed; if no, then step S25 is performed.

In step S22, the computer device obtains data of image files from the image file storage region 61 of the memory unit 6 and displays a list of image files on the display unit 3 for allowing the user to select an intended image file. Then, step S23 is performed.

In step S23, the computer device sets a parameter value for the selected image file in the step S20 to find out a storage address from the image file storage region 61 corresponding to the parameter value of the selected image file and to find out a storage address of a driver for executing the image file. Then, step S24 is performed.

In step S24, the computer device stores the set parameter value in the play setting data region 63 of the memory unit 6.

In step S25, the computer device stores data of the MP3 song selected by the user in the play setting data region 63 of the memory unit 6.

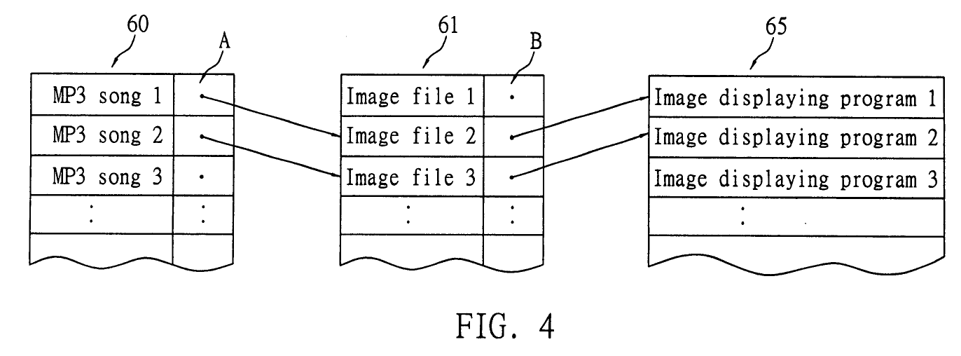

FIG. 4 illustrates correlation between MP3 song files and image files established through the use of the audio and video playing method according to the invention. After performing the procedural steps shown in FIGS. 2 and 3, the play setting data region 63 of the memory unit 6 is adapted to store the parameter value corresponding to the image file associated with the MP3 song selected by the user. As shown in FIG. 4, the parameter value is designated with a storage address A of the image file corresponding to the MP 3 song and a storage address B of a driver (stored in the image displaying program region 65 of the memory unit 6) required for executing the image file. When the computer device receives a song displaying request from the user via the keyboard 2, it executes the MP3 audio and video playing program 62 of the memory unit 6 and determines if a corresponding image file needs to be executed during playing of the MP3 song according to the parameter value stored in the play setting data region 63 to thereby find out a driver for executing the image file.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. An audio and video playing method for being applied to a computer device having a memory unit and a data input unit, the method comprising the steps of:
(1) dividing the memory unit at least into a song storage region, an image file storage region, an audio and video playing program region, and a play setting data region;
(2) when the computer device receives data transferred from the data input unit, determining the type of data via the computer device; if it is an image file, storing the data in the image file storage region of the memory unit; if it is a sound file, storing the data in the song storage region of the memory unit;
(3) having a user set a playing mode via the data input unit of the computer device, wherein the computer device displays data of playing modes on a display unit thereof, and the playing modes at least include a mode for playing songs only and a mode for simultaneously playing songs and displaying images;
(4) when the computer device receives a playing mode for simultaneously playing songs and displaying images from the user, finding out data of songs and image files via the computer device from the song storage region and image file storage region of the memory unit for allowing the user to select an intended song and a corresponding image file;
(5) establishing a form of correlation between songs and image files via the computer device according to the setting and selection made by the user, and storing the correlation form in the play setting data region of the memory unit; and
(6) when the computer device receives a song playing request from the user via the data input unit, executing an audio and video playing program stored in the audio and video playing program region of the memory unit via the computer device in accordance with data stored in the play setting data region.

2. The audio and video playing method of claim 1, wherein the computer device is selected from the group consisting of a desktop personal computer, notebook computer, digital camera, cellular phone, and personal digital assistant.

3. The audio and video playing method of claim 1, wherein the memory unit is selected from the group consisting of a hard disk and a storage memory card.

4. The audio and video playing method of claim 1, wherein the data input unit is an electronic device connected to the computer device for allowing data to be input to the computer device.

5. The audio and video playing method of claim 4, wherein the electronic device is selected from the group consisting of a hard-disk device and a reading device for reading data stored in a storage memory card.

6. The audio and video playing method of claim 3, wherein the storage memory card is selected from the group consisting of a CF (compact flash) card, PCMCIA (personal computer memory card international association) and SM (smart media) card.

7. The audio and video playing method of claim 5, wherein the storage memory card is selected from the group consisting of a CF (compact flash) card, PCMCIA (personal computer memory card international association) and SM (smart media) card.

8. The audio and video playing method of claim 1, wherein the image file storage region stores a plurality of image files of different file formats.

9. The audio and video playing method of claim 8, wherein the image files are of “jpeg”, “gif” and “mpeg” file formats.

10. The audio and video playing method of claim 1, wherein the correlation form is used to store storage addresses of image files corresponding to songs intended to be played and storage addresses of drivers for executing the image files.

11. The audio and video playing method of claim 1, wherein the songs are stored in a MP3 (MPEG audio layer-3) file format.
